(19) United States
(12) Patent Application Publication
(10) Pub. No.: US 2019/0060177 A1
(43) Pub. Date: Feb. 28, 2019

(54) PILL DISPENSER AND DISTRIBUTOR

(71) Applicant: William Leahy, Holyoke, MA (US)

(72) Inventor: William Leahy, Holyoke, MA (US)

(21) Appl. No.: 15/951,145

(22) Filed: Apr. 11, 2018

Related U.S. Application Data
(60) Provisional application No. 62/551,343, filed on Aug. 29, 2017.

(51) Int. Cl. A61J 7/00; B65D 83/04

(52) U.S. Cl. CPC A61J 7/0084; A61J 1/1418; B65D 83/04

(57) ABSTRACT

A device and method of dispensing and distributing materials, such as pills, capsules, and medication, are disclosed. A container of pills or other material may be placed in contact with or in proximity to the device, which may have a curved or contoured bottom surface. Material may be dispensed from the container into the device. An optional barrier may block movement and unintentional distribution or dispensing of the material. Material may be received in a retention area. The barrier may be moved so as to allow for passage of the material. Material may be dispensed from the dispenser and may be distributed onto other surfaces or into other volumes, such as daily, weekly, or monthly pill holders. The barrier may optionally be used to assist in moving the material and in dispensing or distributing the pills or other material.

This application claims the priority of U.S. Provisional Patent Application No. 62/551,343 filed on Aug. 29, 2017, the disclosure of which is incorporated herein in its entirety.

### BACKGROUND

The present disclosure relates generally to a device for dispensing and distributing materials. More particularly, the present disclosure relates to a device which aids in dispensing pills, capsules, medications, or other materials, from a container, such as a pill bottle, while also being able to aid in distributing the materials to secondary containers, such as pill organizers.

It can often be difficult to transfer material from one container to another, especially when the first container includes a large amount of material which must be dispensed across multiple smaller containers. This is a particular problem when dealing with materials such as pills, capsules, and other medication. A user may be given the medication in a container which contains multiple units, such as a pill bottle which may contain a supply of pills which is meant to last a week, a month, a year, or even longer. The user may wish to subdivide the pills or other medication into daily, weekly, or other manageable quantities. As an example, a user may wish to take a six month supply of pills and fill a monthly medication dispenser with individual pills for separate days. This may be easier to manage for the user, easier to track, or may allow the user to ensure that the correct medication, in the correct quantity, is taken on the correct day or at the correct time. A user may, similarly, take a monthly or other supply of medication and wish to divide it into a smaller quantity, such as a weekly amount, which can be tracked on a daily basis or may be easier or otherwise more convenient to travel with.

Weekly pill “planners” are well known in the art, often comprising seven separate chambers, often also including the day of the week on a cover to each chamber. A user places the medication for that day in the appropriate chamber, thus being able to have a week of medication on hand, while also being more easily able to take a given day's medication on the correct day. Similar monthly planners are also known in the art, often requiring larger quantities of pills, with different pills with different medications or amounts of medication, or even placebos, for different days. Despite the prevalence of various containers for carrying pills and other materials, there remains a difficulty in transferring pills from the original container to the secondary ones.

A general problem exists in transferring pills or other medication or materials to a secondary container. Problems are often due to the number of pills in the first container, the size of the first container, and the size of the compartment in the second container. A user may have difficulty pulling or dispensing individual pills or material from a first container. A user may need to dump out some or all of the first container, such as into their hand or onto a table. Some pills may thus fall onto the floor or may contact a surface which is not sanitary. The pills may become dirty, wet, or otherwise contaminated. Contaminated pills may need to be discarded, may be inadvisable to use, or may otherwise not be available for use. Even pills that are not contaminated or lost may be difficult for a user to place into a smaller compartment in a secondary container or may be difficult to pick up and manipulate due to their size. Difficulties in removing pills from a container, in picking up pills, in coordination to prevent dropping pills, and in placing individual pills into a small compartment, are especially prevalent among the elderly or among those suffering from diseases or medical conditions, such as arthritis. Many times, these are the users who may have the most need for carrying and sorting medication, while also often being the very users who may have the most difficulty in accessing and dispensing it. Such difficulties can further increase with smaller pills, greater quantities of pills, or powdered materials.

### SUMMARY

The disclosure relates generally to a device for dispensing and distributing materials. More particularly, the present disclosure relates to a device which aids in dispensing pills, capsules, medications, or other materials, from a container, such as a pill bottle, while also being able to aid in distributing the materials to secondary containers, such as pill organizers. The disclosed device and method relate to aiding a user in transferring material, such as pills, from one container to a second container, volume, or surface.

In one embodiment, the device is a pill dispenser. The pill dispenser extends over a length and may have a first wall and a second wall. The first wall and the second wall may be on either side of a longitudinal axis which extends substantially along the length of the pill dispenser. The pill dispenser may also include a surface which is configured to receive a container, such as a pill bottle. The container receiving surface may further be substantially parallel to the base of the pill dispenser or may be at least partially curved, such as including an at least partial concavity designed to receive cylindrical containers or containers with a convex surface. The concave feature of the surface may also be configured to aid in retaining a container against or proximate to the pill dispenser. The bottom surface of the pill dispenser may be substantially planar, convex, concave, or may include a combination of such or other features. The pill dispenser may include a dispensing tip, which may further include a dispensing end, which may be at an end of the pill dispenser distal to the container receiving surface, relative to the longitudinal axis.

At least part of the volume defined by the first wall on one side and the second wall on the other side may be a receiving volume, such as for receiving pills or other material which are to be dispensed. The receiving volume may be defined on a third side by a container which may be placed against the pill dispenser. The receiving volume may also be defined on a third side by the container receiving surface, by a ramp, curved feature, or other feature which may at least partially separate the receiving volume from the container receiving surface. A combination of features may also define the receiving volume on the third side. The receiving volume may be defined on a fourth side by the dispensing tip, by a dispensing volume, by a ramp, curved surface, or by another feature. The receiving volume may also be defined on the fourth side by a barrier, which may be removable or rotatably connected to the pill dispenser. The receiving volume may be at least partially open on the third side, so as to allow for entrance of pills or other material into the receiving volume. The receiving volume may be at least partially open on the fourth side, so as to allow for pills or other material to be moved from the receiving volume or otherwise dispensed from the pill dispenser. The receiving volume may be at least partially closed by a surface at a top side or may be completely open at a top side. The bottom side of the receiving volume may be defined by a surface, features, or surfaces, which may be substantially planar, may be convex, may be concave, may be otherwise curved, may be angled relative to the bottom surface of the pill dispenser, or may include other features to aid in retention of pills or other material within the receiving volume. The bottom of the receiving volume, when viewed cross-sectionally, may be at least partially planar, convex, concave, or otherwise curved. The bottom of the receiving volume, when viewed in this way, may also include ramped or other complex curved surfaces or features. When viewed from above the pill dispenser, the receiving volume may include a recessed or proud feature which may be substantially circular, elliptical, rectangular, triangular, or any other shape which may be beneficial in retaining pills and other material.

In a further embodiment, the first wall and the second wall may extend substantially away from the bottom of the pill dispenser. One or both of the walls may extend upwards relative to the bottom surface, and one or both may be at least partially planar or curved. One or both of the first wall and the second wall may extend upwards, or one or both may extend radially along the longitudinal axis. One or both of the first wall and the second wall may extend substantially radially relative to the bottom surface or the container receiving surface if one or both of the bottom surface and the container receiving surface are curved. The container receiving surface may be at least partially concave, and the bottom surface may be at least partially convex. In one embodiment, the bottom surface includes at least one convex surface and at least one substantially planar surface.

In one embodiment, the dispensing tip may at least partially define an opening. Pills or other material may be dispensed at least partially through this opening. The dispensing opening may be of any shape which is deemed appropriate for dispensing pills or other material, such as circular or semi-circular, elliptical, rectangular, triangular, trapezoidal, or other shapes. The dispensing opening may also be a combination of various shapes and features.

In another embodiment, a blocking surface may be proximate to the first wall, the second wall, or both. The blocking surface may also be proximate to the container receiving surface. The blocking surface may aid in aligning the container and may also be configured to receive a plurality of shapes or sizes of containers. The blocking surface may be ramped, angled, or curved so as to aid in directing pills or other material from the container and towards the receiving volume. The blocking surface may be substantially perpendicular to the container receiving surface, or may be at another angle to it, such as to aid in directing material or aligning one or more containers with the pill dispenser. The blocking surface may include on or more recesses or steps configured to align with one or more diameters or sizes of containers. The blocking surface may include one or more threaded or partially threaded features so as to aid in retaining a container against the pill dispenser. Multiple blocking surfaces may also be included in the pill dispenser.

In one embodiment, the pill dispenser may be made at least partially of plastic. In another embodiment, the pill dispenser may be made at least partially of metal. The pill dispenser may also be made at least partially of a composite material, or of a combination of different materials which are known in the art. The barrier may be made of the same material as the pill dispenser, or it may be made of one or more different materials.

In a further embodiment, one or both of the first wall and the second wall may define an opening or a slot. The opening may be configured to receive the barrier. The opening may be configured to receive the entire width of the barrier or one or more surfaces or other features of the barrier. The opening or openings may be configured or located so that the barrier may at least partially separate the receiving volume from the dispensing end, from the dispensing opening, or from a dispensing volume located between the dispensing end and the receiving volume. The barrier may include a bottom surface, which may be substantially planar or may be only partially planar. The bottom surface of the barrier may also be at least partially convex or concave. In another embodiment, part of a bottom surface of a dispensing volume which is located between the dispensing end and the receiving volume may be configured to substantially or partially align with the bottom surface of the barrier. In another embodiment, part of the bottom surface of the receiving volume may be configured to align at least partially with the bottom of the barrier. The bottom of the barrier may be configured to align in contact with the pill dispenser, may include an offset, or may include other gaps.

In a further embodiment, the first wall, the second wall, or both, may include one or more top surfaces. These top surfaces may be configured so as to permit the barrier to slide along the top surfaces, such as along a slot or recess in the barrier. The barrier may be able to slide at least partially through the receiving volume, at least partially through the dispensing volume, or both.

In some embodiments, the bottom surface of the barrier may be configured to substantial align with at least part of the material receiving surface, such as with substantially matching flats or substantially matching curved surfaces, or both. The first wall or second wall top or generally upper surface may be configured to allow a barrier member to slide at least partially through the material receiving volume while maintaining contact with the upper wall surface for a substantial portion of the travel, such as during all of the travel except when passing over a slot in the upper wall surface.

In one embodiment, the dispensing tip is configured to fit at least partially within a target volume, such as a compartment in a pill organizer. The dispensing tip may be partially or fully inserted into the compartment when pills or other material are being dispensed into the compartment. The dispensing tip may include one or more angled sides, such as to reduce the width of the pill dispenser at the dispensing end. The dispensing tip may also be angled or chamfered at a top or bottom surface of the dispensing tip. In a further embodiment, the dispensing tip may be curved or may include one or more curved surfaces, such as to reduce the width or height of the pill dispenser proximate to the dispensing opening.

A user may use the pill dispenser by placing a container of material, such as a pill bottle, proximate to it, against it, or generally within a volume bounded on at least one side by the container receiving surface. A user may shake or angle the pill bottle so that pills fall onto the container receiving surface or into the receiving volume. A user may set the pill bottle against the container receiving surface and allow pills to empty into the pill dispenser and into the receiving volume. The pill dispenser may be held or set at an angle or may be substantially flat, such as when resting on a table or other surface. The pill dispenser may also be placed on or against a pill bottle while the bottle is upright. When the pill dispenser and bottle are angled away from the upright position, pills may fall from the bottle into the pill dispenser.

Pills or other material may fall or slide out of the receiving volume into a dispensing volume or directly out of the dispensing opening. The dispenser opening may be placed against, into, or proximate to another surface or a container, such as a compartment in a pill organizer. Separate compartments within a pill organizer, such as those assigned to separate days or times when medication may be taken, may be filled by pills from the pill dispenser.

In one method of use, a user may connect a barrier to the pill dispenser or may rotate a barrier into position. The barrier may be connected or rotated into position prior to dispensing pills from a pill bottle into the receiving volume, thus decreasing the likelihood of dropping pills or unintentionally dispensing them. The barrier may at least partially separate the receiving volume from the dispensing tip, from the dispensing opening, or from the dispensing volume.

A user may at least partially remove the barrier or at least partially rotate it out of blocking position, so that pills or other material may move from the receiving volume to the dispensing volume, the dispensing tip, or the dispensing opening. In one method of use, a user may slide the barrier at least partially through the receiving volume, aiding in moving the pills or other material out of the receiving volume. In another method, a user may slide the barrier at least partially through the dispensing volume, aiding in dispensing pills or other material from the dispensing tip or in better controlling how pills or other material are dispensed.

The disclosure relates generally to electronic devices and displaying advertising, such as through the use of the described method and invention. The method may include the use of software or a device which may include one or more of the features, steps, or components described herein. Any number of steps or elements may be used in conjunction with the method described, and various means for displaying advertising may be incorporated.

It is to be understood that the above mentioned steps and features and the steps and features yet to be explained hereinafter can be used not only in the respectively mentioned combinations but also in other combinations or alone without departing from the context of the present invention.

### BRIEF DESCRIPTION OF THE DRAWINGS

The invention is now disclosed in detail with reference to exemplary embodiments shown in the accompanying drawings, where:

FIG. 1 shows a front top isometric view of an embodiment of the pill dispenser and barrier of the present disclosure;

FIG. 2 shows a front top isometric view of the embodiment of the pill dispenser and barrier of FIG. 1 with a bottle;

FIG. 3 shows a front top isometric view of the embodiment of the pill dispenser and barrier of FIG. 1 with a pill container;

FIG. 4 shows a front top isometric view of the embodiment of the pill dispenser of FIG. 1;

FIG. 5 shows a top view of the embodiment of the pill dispenser of FIG. 1;

FIG. 6 shows a front view of the embodiment of the pill dispenser FIG. 1;

FIG. 7 shows a side view of the embodiment of the pill dispenser of FIG. 1,

FIG. 8 shows a side cross-sectional view of the embodiment of the pill dispenser of FIG. 1;

FIG. 9 shows a rear bottom isometric view of the embodiment of the pill dispenser of FIG. 1;

FIG. 10 shows a front top isometric view of an alternate embodiment of the pill dispenser of the present disclosure;

FIG. 11 shows a top view of the embodiment of the pill dispenser FIG. 10;

FIG. 12 shows a front top isometric view of another embodiment of the pill dispenser of the present disclosure;

FIG. 13 shows a top view of the embodiment of the pill dispenser of FIG.

FIG. 14 shows a side view of the embodiment of the pill dispenser FIG. 12;

FIG. 15 shows a rear view of the embodiment of the pill dispenser of FIG. 12;

FIG. 16 shows a front top isometric view of another embodiment of the pill dispenser of the present disclosure;

FIG. 17 shows a top view of the embodiment of the pill dispenser of FIG. 16,

FIG. 18 shows a rear view of the embodiment of the pill dispenser of FIG. 16;

FIG. 19 shows a side view of the embodiment of the pill dispenser of FIG. 16;

FIG. 20 shows a side cross-sectional view of the embodiment of the pill dispenser of FIG. 16;

FIG. 21 shows a front top isometric view of another embodiment of the pill dispenser of the present disclosure;

FIG. 22 shows a top view of the embodiment of the pill dispenser of FIG. 21,

FIG. 23 shows a rear view of the embodiment of the pill dispenser of FIG. 21;

FIG. 24 shows a side view of the embodiment of the pill dispenser of FIG. 21;

FIG. 25 shows a side cross-sectional view of the embodiment of the pill dispenser of FIG. 21;

FIG. 26 shows a front top isometric view of another embodiment of the pill dispenser of the present disclosure;

FIG. 27 shows a top view of the embodiment of the pill dispenser of FIG. 26;

FIG. 28 shows a rear view of the embodiment of the pill dispenser of FIG. 26;

FIG. 29 shows a rear bottom isometric view of the embodiment of the pill dispenser of FIG. 26;

FIG. 30 shows a front view of the embodiment of the pill dispenser of FIG. 26;

FIG. 31 shows a side view of the embodiment of the pill dispenser of FIG. 26;

FIG. 32 shows a side cross-sectional view of the embodiment of the pill dispenser of FIG. 26;

FIG. 33 shows a front top isometric view of another embodiment of the pill dispenser of the present disclosure;

FIG. 34 shows a rear view of the embodiment of the pill dispenser of FIG. 33;

FIG. 35 shows a front top isometric view of another embodiment of the pill dispenser of the present disclosure;

FIG. 36 shows a top view of the embodiment of the pill dispenser of FIG. 35;

FIG. 37 shows a rear view of the embodiment of the pill dispenser of FIG. 35;

FIG. 38 shows a front view of the embodiment of the pill dispenser of FIG. 35;

FIG. 39 shows a rear bottom isometric view of the embodiment of the pill dispenser of FIG. 35;

FIG. 40 shows a side view of the embodiment of the pill dispenser of FIG. 35;

FIG. 41 shows a side cross-sectional view of the embodiment of the pill dispenser of FIG. 35;

FIG. 42 shows a front top isometric view of another embodiment of the pill dispenser of the present disclosure;

FIG. 43 shows a top view of the embodiment of the pill dispenser of FIG.

FIG. 44 shows a rear view of the embodiment of the pill dispenser of FIG. 42;

FIG. 45 shows a front view of the embodiment of the pill dispenser of FIG. 42;

FIG. 46 shows a side view of the embodiment of the pill dispenser of FIG. 42;

FIG. 47 shows a side cross-sectional view of the embodiment of the pill dispenser of FIG. 42;

FIG. 48 shows a front top isometric view of an embodiment of the barrier of the present disclosure;

FIG. 49 shows a front view of the embodiment of the barrier of FIG. 48;

FIG. 50 shows a front view of another embodiment of the barrier of the present disclosure;

FIG. 51 shows a front view of another embodiment of the barrier of the present disclosure;

FIG. 52 shows a front view of another embodiment of the barrier of the present disclosure;

FIG. 53 shows a front view of another embodiment of the barrier of the present disclosure;

FIG. 54 shows a front top isometric view of another embodiment of the pill dispenser of the present disclosure;

FIG. 55 shows a side cross-sectional view of the embodiment of the pill dispenser of FIG. 54;

FIG. 56 shows a front top isometric view of another embodiment of the pill dispenser of the present disclosure;

FIG. 57 shows a front view of the embodiment of the pill dispenser of FIG. 56;

FIG. 58 shows a back view of the embodiment of the pill dispenser of FIG. 56;

FIG. 59 shows a bottom view of the embodiment of the pill dispenser of FIG. 56; and

FIG. 60 shows a side cross-sectional view of the embodiment of the pill dispenser of FIG. 56.

### DETAILED DESCRIPTION

Exemplary embodiments of the disclosure are illustrated in the Figures and are explained in the following description in more detail, wherein identical reference numbers refer to identical, or similar, or functionally identical or similar components.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials, steps, and configurations are set forth in order to provide a thorough understanding of the illustrative embodiments. However, it will be apparent to one skilled in the art that the present invention may be practiced without the specific details. In other instances, well-known features or those previously described are omitted or simplified in order not to obscure the illustrative embodiments.

Various operations may be described as multiple discrete operations, in turn, in a manner that is most helpful in understanding the present invention, however the order of description should not be construed as to imply that these operations are necessarily order dependent. In particular, these operations need not be performed in the order of presentation. In some instances, structures and devices may be shown in block diagram or flow chart form in order to facilitate describing the disclosed subject matter.

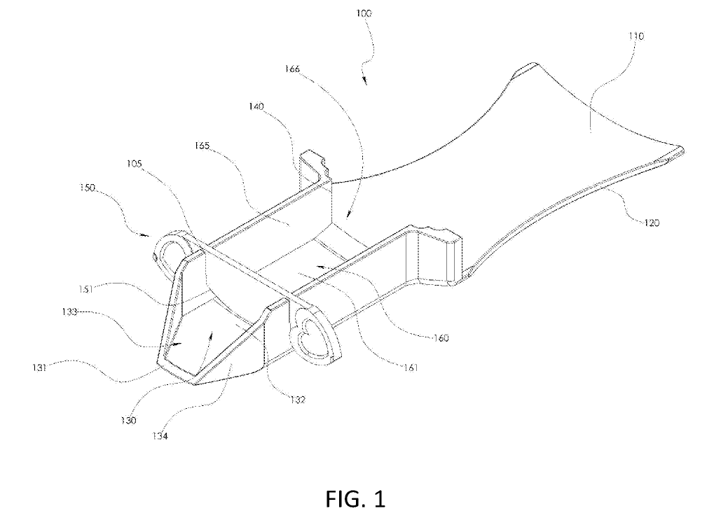

FIG. 1 shows a front isometric view of an embodiment of the pill dispenser 100 and an embodiment of the barrier 150 of the present disclosure. The pill dispenser 100 may include a substantially curved container receiving surface 110 which may also be substantially open in at least one direction. The pill dispenser 100 may be made of any suitable material, such as a plastic, metal, or composite. The pill dispenser 100 may be substantially rigid or it may be flexible. In one embodiment, the pill dispenser 100 is configured so as to be adequately rigid to support a pill bottle 190 while being held in a user's hand. The pill dispenser 100 may also be made of multiple materials or varying wall thicknesses or densities so as to allow for desired rigidity, strength, and weight. In one embodiment, the pill dispenser 100 may comprise food-grade materials, inert materials, or one or more other materials which would be permitted by regulations to be in contact with medication or edible substances.

The pill dispenser 100 may include one or more at least partially curved gripping surfaces 120. The one or more gripping surfaces 120 may be configured to accommodate a user's hand or fingers. The pill dispenser 100 may also include one or more funnelling surfaces 140. The funnelling surfaces 140 may be configured so as to retain pills, other medication, capsules, or other material, when being dispensed from a bottle 190 or other container into the pill dispenser 100. The funnelling surface or surfaces 140 may also direct material towards a receiving area 160, which may have one or more receiving walls 165 and may include one or more openings. In one embodiment, the receiving area 160 may be open on one end so as to be able to receive materials. The receiving area 160 may be open on a second end, leading to a dispensing area 130, dispensing tip 131, or both.

A barrier 150 may be included which may block the material from passing between the receiving area 160 and the dispensing area 130 or dispensing tip 131. The barrier 150 may be selectively and at least partially openable. The barrier 150 may also be selectively removable. In one embodiment, the barrier 150 fits into one or more slots 105 in the pill dispenser 100 so as to separate the receiving area 160 from the dispensing area 130 or dispensing tip 131. The barrier 150 may be removably or rotatably connected to the pill dispenser 100. The barrier 150 may include a lower surface 151 which may be configured so as to prevent, reduce, or minimize the passage of material under or around the barrier 150. The lower surface 151 may be configured so as to at least partially conform to the complementary surface 132 of the pill dispenser 100 when the barrier 150 is separating the receiving area 160 from the dispensing area 130. The lower surface 151 may also be configured so as to substantially conform to the complementary surface 132 of the dispensing area 130. In one embodiment, the lower surface 151 of the barrier 150 is configured so as to at least partially conform to an upper surface 161 of the pill dispenser receiving area 160. In such an embodiment, the barrier 150 may be used to assist in sliding material from the receiving area 160 to the dispensing area 130. In an embodiment where the lower surface 151 of the barrier 150 is configured to at least partially conform to an upper surface 132 of the dispensing area 130 the barrier 150n may be used to assist in sliding material away from the back portion of the dispensing area 130.

The pill dispenser 100 may include a dispensing tip 131. The dispensing tip 131 may include an opening 133 which may permit the passage of material from the dispensing area 130 and out of the pill dispenser 100. The dispensing tip 131 may be configured to direct material or may be configured so as to fit up to or into a target volume. In one embodiment, the dispensing tip 131 includes at least one angled surface 134 so as to fit at least partially into a target volume.

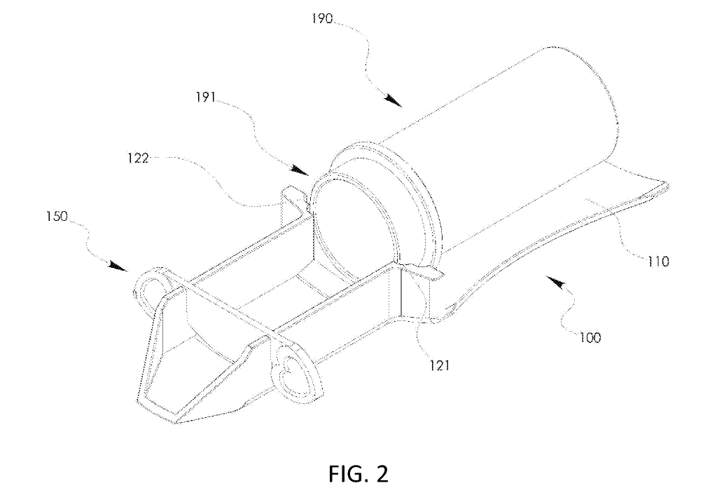

FIG. 2 shows a pill bottle 190 resting against a receiving surface 110. Though a pill bottle 190 is shown, it should be understood that other types of containers may also be used or may also be compatible with embodiments of the pill dispenser 100. The open end 191 of the bottle 190 is shown resting substantially against a bottle retention feature 121. The bottle retention feature 121 may be a flat surface, may be curved, may be angled, such as a ramp, or may include other features configured to receive one or more bottles 190 or other containers. In the embodiment shown, the bottle retention feature 121 includes multiple steps 122 which are configured to receive different diameters or sizes of bottles 190, though it should be understood that fewer steps 122, a single step 122, no steps 122, or more steps 122, may also be used without deviating from the intent of this disclosure.

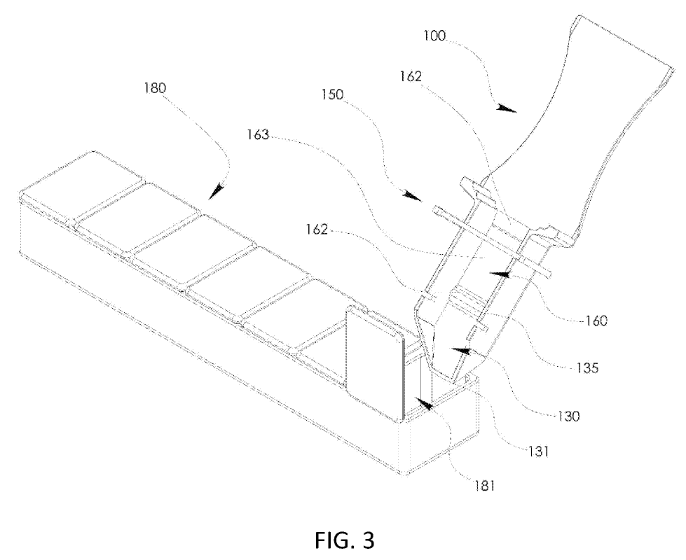

FIG. 3 shows a pill dispenser 100 which is in position to deliver material to a target volume 181. A daily medication container 180 is shown, including multiple volumes 181 which receive medication for different days. It should be understood, however, that the pill dispenser 100 may be configured to dispense into other volumes 181 or may be used with other target volumes 181 or target surfaces.

In the embodiment shown, the barrier 150 has been placed in the receiving area 160. The bottle 190 has been removed, so as not to allow for additional or unwanted material to fall out of the bottle 190. In one method of use, a user would place the barrier 150 into or against the pill dispenser 100 so as to separate the receiving area 160 from the dispensing area 130. The pill dispenser, or the bottle 190 and pill dispenser 100 together, if still in contact with each other, may be angled or shaken so as to facilitate material to leave the bottle 190 or funnelling surface 140 and enter into the receiving area 160. The bottle may be removed 190. The pill dispenser 100 may be placed into or in proximity to a target volume 181 or target surface. The barrier 150 may be moved so as to allow for material to slide out of the receiving area 160 and into the dispensing area 130 and out through the dispensing tip 131, or material may slide directly out of the dispensing tip 131. In the embodiment shown, the barrier 150 is configured so as to be slidable through at least part of the receiving area 160 and at least part of the dispensing area 130, thus being able to aid in moving material towards the target volume 181. The barrier 150may be configured to be slidable within the dispensing area 130, the receiving area 160, both, or neither.

It should be understood that the pill dispenser 100 may alternatively not include a dispensing area 130. Material to be dispensed may be received in a receiving area 160, and then removal of the barrier 150 may allow for material to dispense from the pill dispenser 100 directly from the dispensing tip 131.

In the embodiment shown, the receiving area 130 has an angled retention surface 162 at each end. These angled retention surfaces 162 aid in retaining material in the receiving area 160 when the barrier 150, the bottle 190, or both, are not in place. The pill dispensing area 130 may include an angled retention surface 135 at one end of the receiving area 130, at both ends, or at neither. One or both angled surfaces 135,162 may also be curved instead of angled or may be both angled and curved. The receiving area 160 may also include a recess or concavity 163, instead of or in addition to angled or other curved surfaces 162, to aid in retention of material.

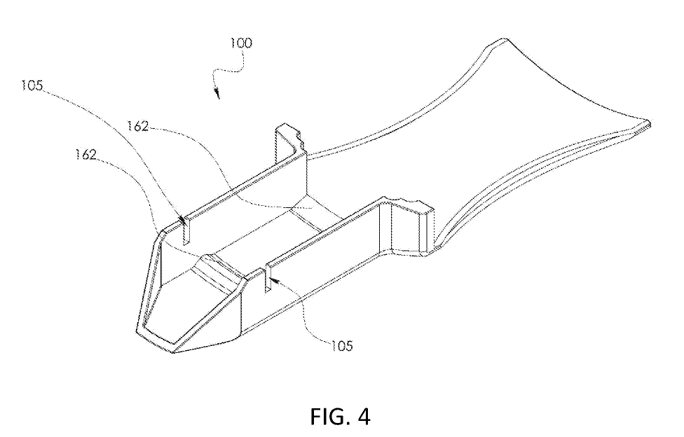

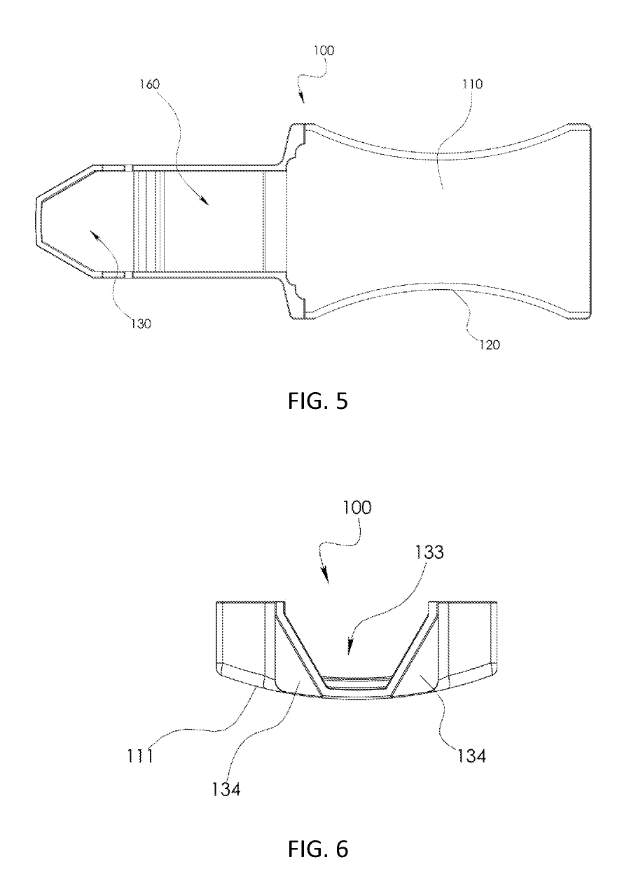

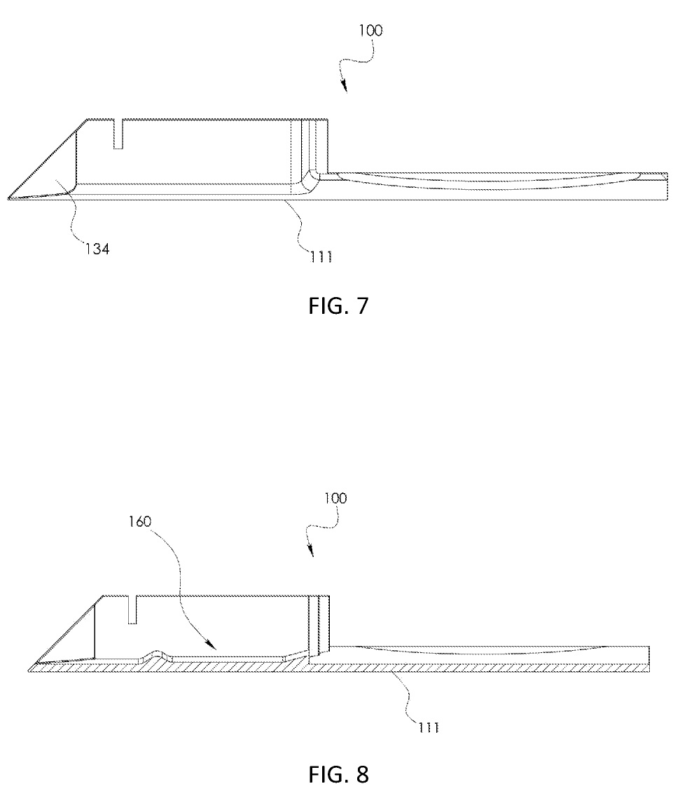

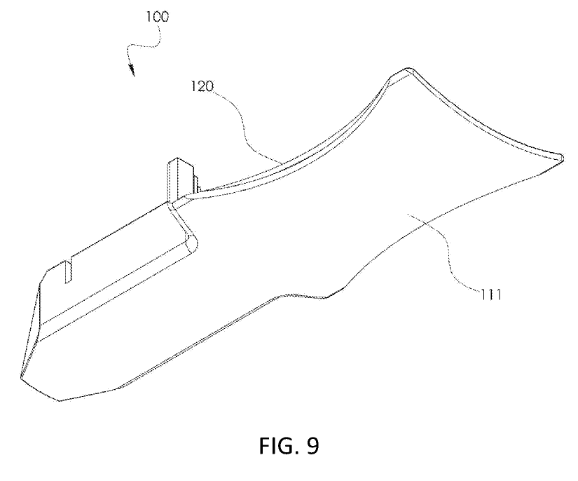

FIG. 4 shows a front top isometric view of the pill dispenser 100. Angled and curved surfaces 162 are shown at either end of the receiving area 160. The upper surface 161 of the receiving area 160 is also curved. The bottom surface 111 of the pill dispenser 100 may have a matching curvature, may have a different curvature, or may be at least partially planar. FIG. 5 shows a top view of the pill dispenser 100, including a receiving area 160 and a dispensing area 130. FIG. 6 shows a front view of the pill dispenser 100. In the embodiment shown, the bottom surface 111 of the pill dispenser 100 has a substantially uniform curvature, though it should be understood that the bottom of the pill dispenser 100 may also be at least partially planar, or, in alternative embodiments, may be substantially planar. The dispensing tip 131 is angled on two sides so as to more easily feed material into a target volume 181. It should be understood that the dispensing tip 131 may have only one angled surface 134, no angled surfaces 134, or more angled surfaces 134. The dispensing tip 131 may also feature an at least partially curved surface. FIG.7 shows a side view of the pill dispenser 100. FIG. 8 shows a side cross-sectional view of the pill dispenser 100. The receiving area 160 appears substantially planar in cross-section, though it may be curved, concave, convex, or at least partially planar. FIG. 9 shows a rear bottom isometric view of the pill dispenser 100.

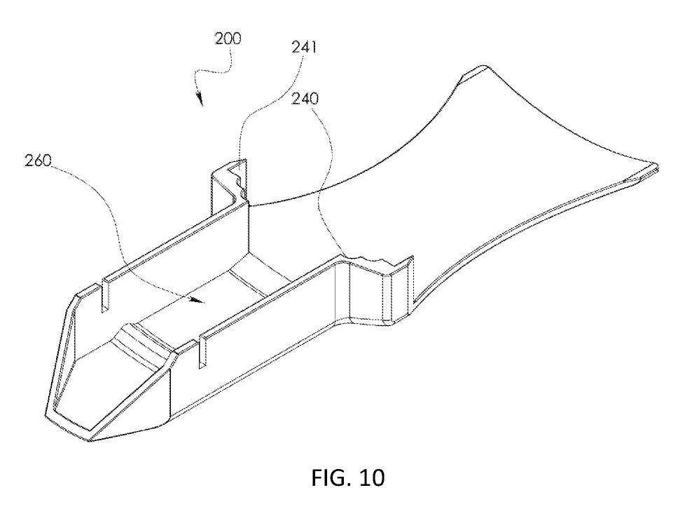

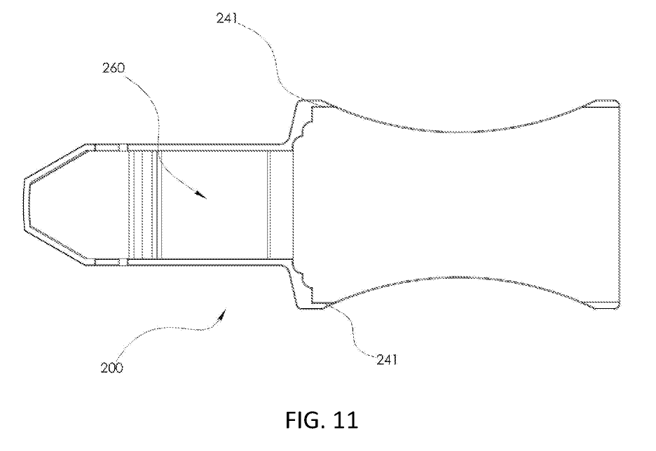

FIG. 10 shows a front top isometric view of a pill dispenser 200. The receiving feature 240 is at least partially bounded by one or more sidewalls 241. The sidewalls 241 may aid in retaining larger containers or may enable a container, such as a relatively larger container, to be used while reducing the likelihood of pills or other material dropping out of the pill dispenser 200. The sidewalls 241 may aid in retaining material after it leaves the container and prior to entering the receiving area 260. The sidewalls 241 may aid in funnelling or otherwise directing material towards the receiving area 260. The sidewalls 241 may aid in retaining the container in contact with or in a desired location relative to the pill dispenser 200. FIG. 11 shows a top view of the pill dispenser 200.

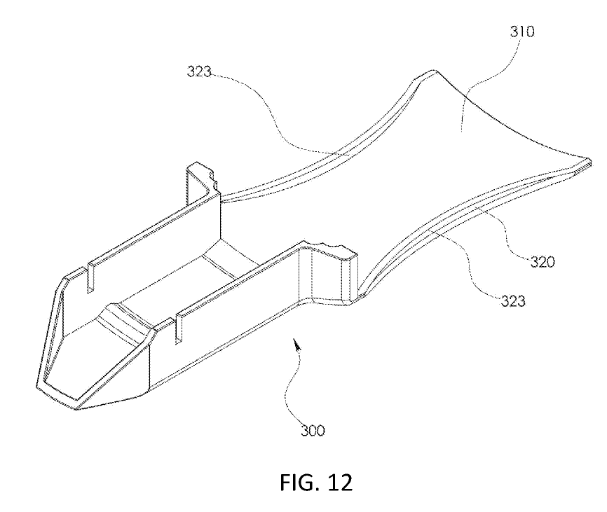

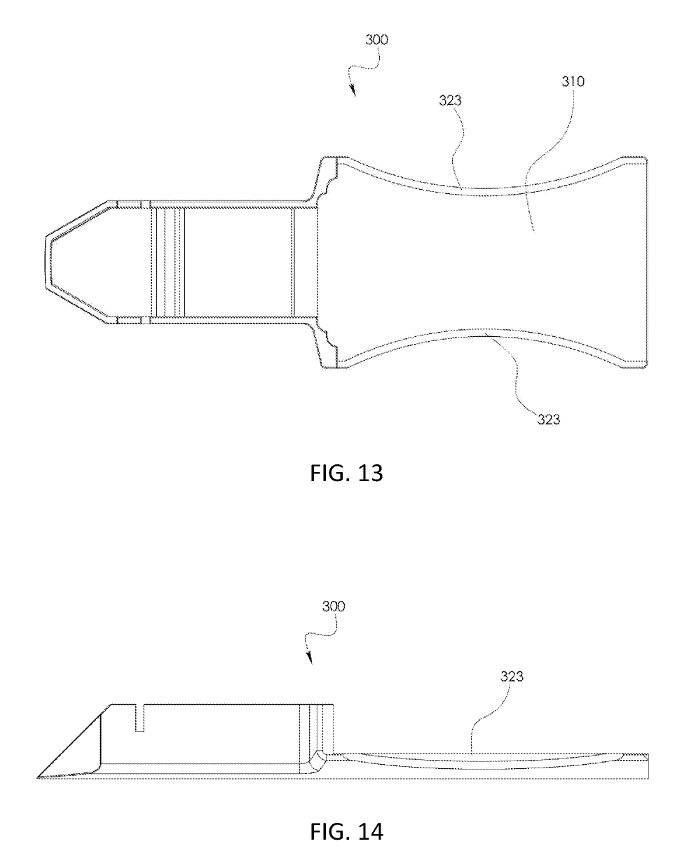

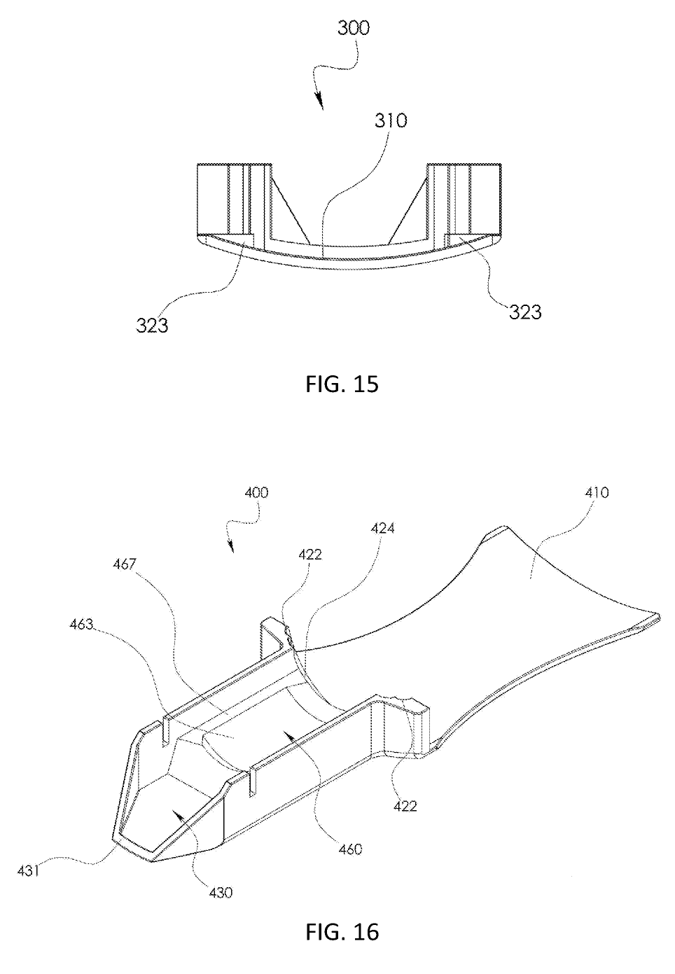

FIG. 12 shows front top isometric view of a pill dispenser 300. One or more of the gripping surfaces 320 may include an at least partial wall 323 which may extend upwards at least partially away from the receiving surface 310, downwards, or both. The wall 323 may provide additional rigidity to the pill dispenser 300 or to where a user is likely to hold it. The wall 323 may also provide a more comfortable or otherwise larger gripping feature 320. In embodiments where the wall 323 extends at least partially upwards, it may aid in retention of a bottle 190 or other container or in retention of pills or other material. In embodiments where the wall 323 may extend at least partially downwards, the wall 323 may also provide increased rigidity, improved gripping, or more stability for the pill dispenser 300, such as when it is placed on a substantially flat surface. FIGS. 13, 14, and 15 show a top view, side view, and rear view, respectively, of the pill dispenser 300.

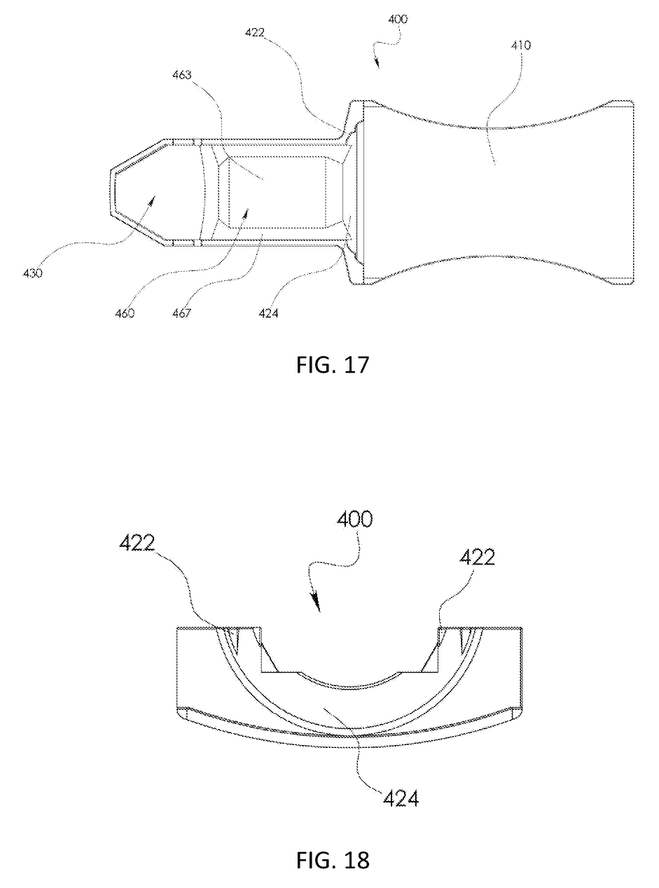

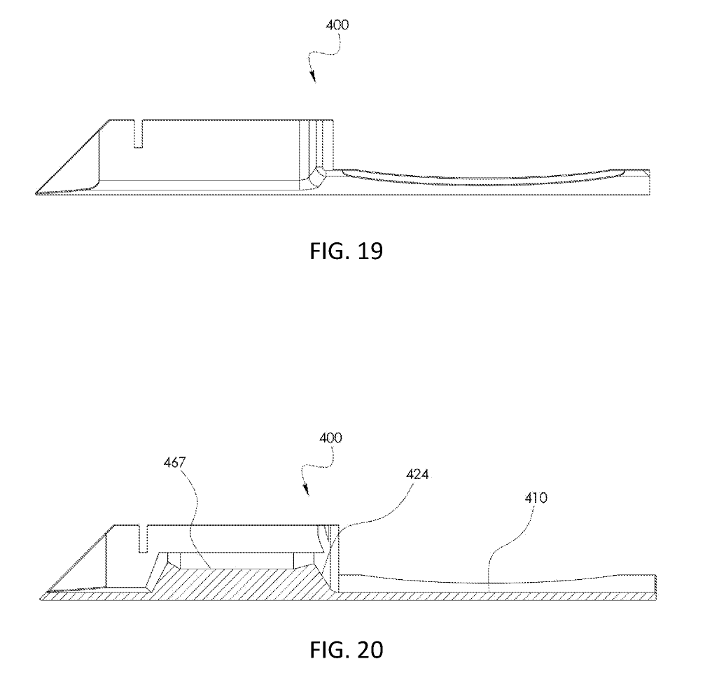

FIG. 16 shows a front top isometric view of a pill dispenser 400. The pill dispenser 400 may include steps 422 for receiving a range of sizes of containers. The pill dispenser 400 may include a ramp 422, which may be at least partially curved, to aid in directing material from a container to the receiving area 410. The ramp 424 may also reduce the likelihood of material falling to the sides or under a container prior to entering the retention area 460. The retention area 460 is shown elevated at least partially above the receiving surface 410 and the dispensing area 430. It should be understood that the retention area 460 may be even with one or both of the receiving surface 410 and the dispensing area 430, may be above one or both, or may be below one or both. The retention area 460 may include an at least partially concave surface 463. The retention area 460 may also include one or more substantially planar surfaces 467. Either the concave surface 463, the planar surfaces 467, or both, may be configured to interface with the barrier 150 so as to aid in moving material from the retention area 460 to the dispensing area 430 or to the dispensing tip 431. FIGS. 17, 18, 19, and 20, show a top view, rear view, side view, and side cross-sectional view, respectively, of the pill dispenser 400.

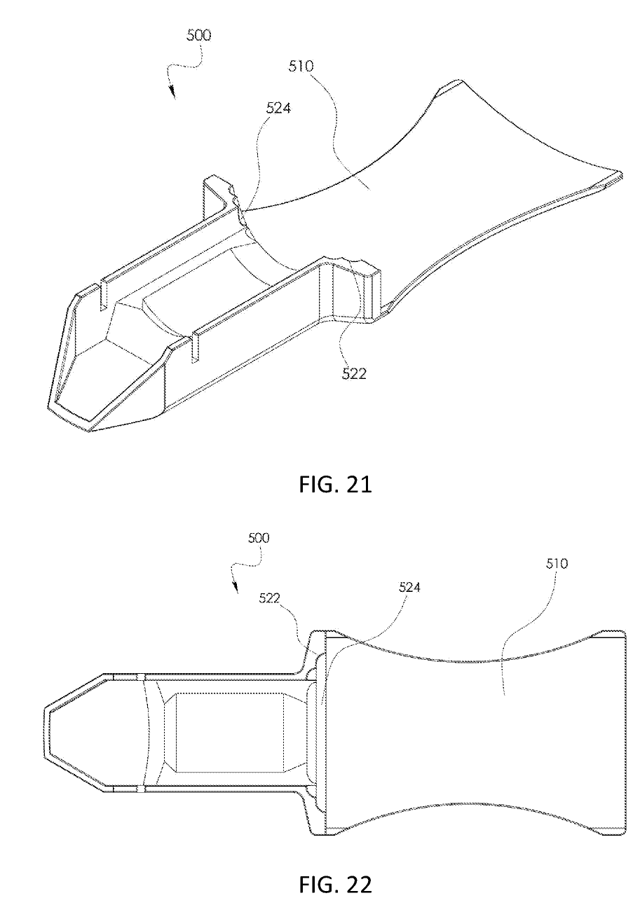

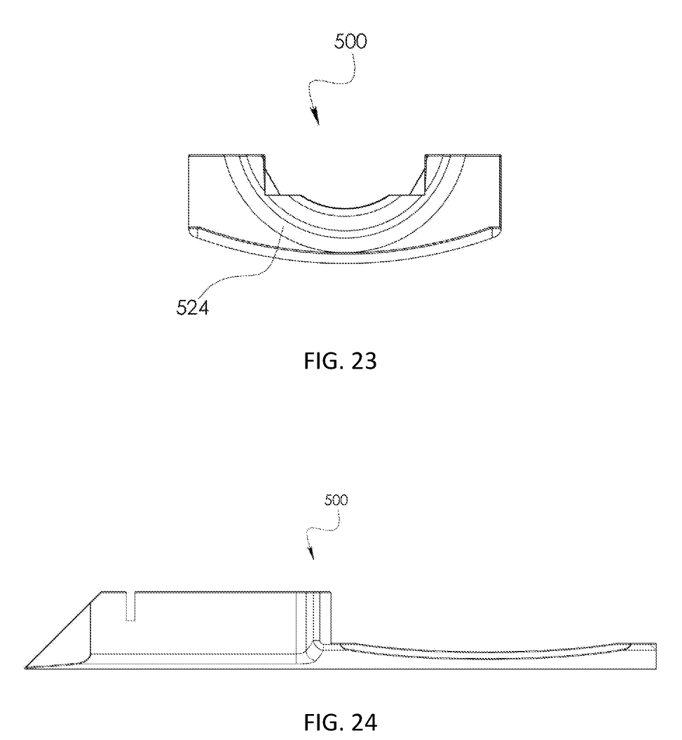

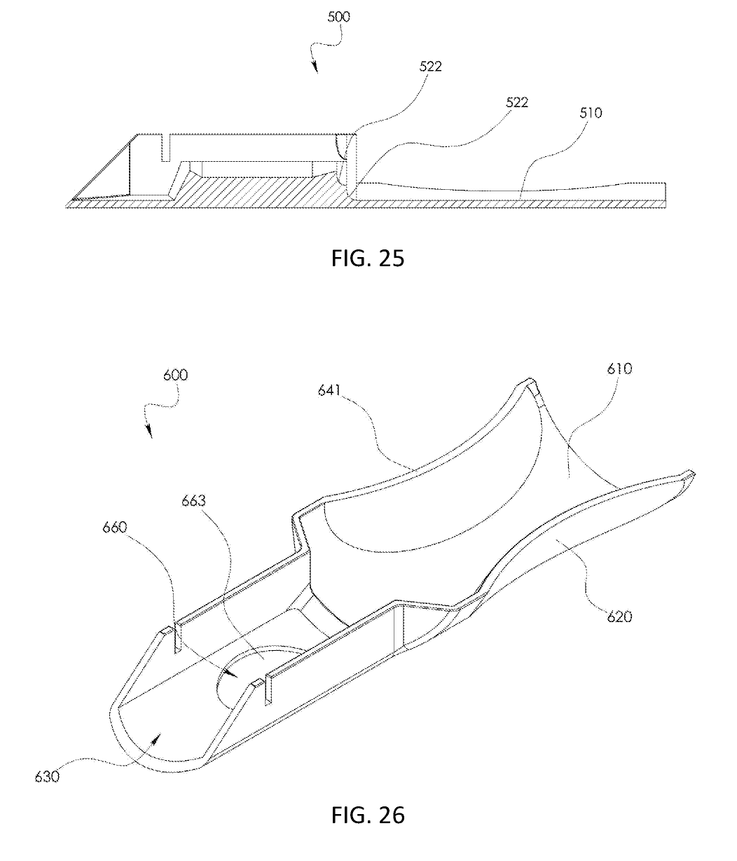

FIG. 21 shows a front top isometric view of a pill dispenser 500. The ramp surface 524 leading into the receiving area includes a plurality of curves which are configured to at least partially conform to the steps 522 of the pill dispenser 500. A stepped ramp 524 may aid in better aligning different diameters of bottles 190 or other containers with the pill dispenser 500 and may allow a bottle 190 to sit more evenly against the receiving surface 510. FIGS. 22, 23, 24, and 25, show a top view, a rear view, side view, and a side cross-sectional view, respectively, of the pill dispenser 500.

FIG. 26 shows a front top isometric view of an alternate embodiment of a pill dispenser 600. The pill dispenser 600 includes a recessed retention surface 663 in the retention area 660. The retention area 660 may be substantially circular, elliptical, rectangular, triangular, or any other shape which may be deemed to appropriately retain or resist movement of pills or other material. The retention area 660 may be substantially below the receiving surface 610 or the dispensing area 630. The retention area 660 may also be only minimally below one or more of those surfaces, so as to partially impede movement of material or reduce the likelihood for material to substantially move around relative to the pill dispenser 600.

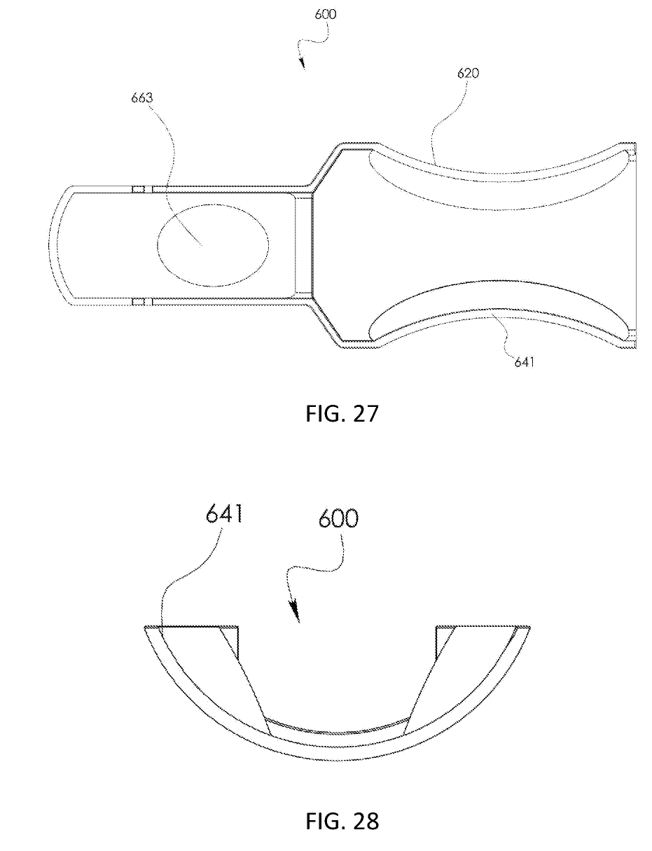

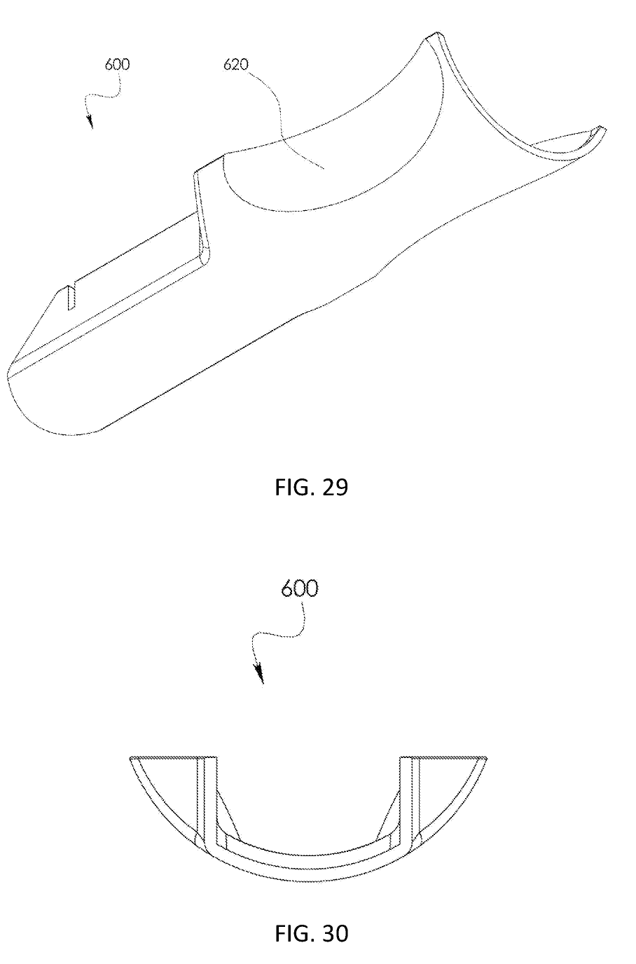

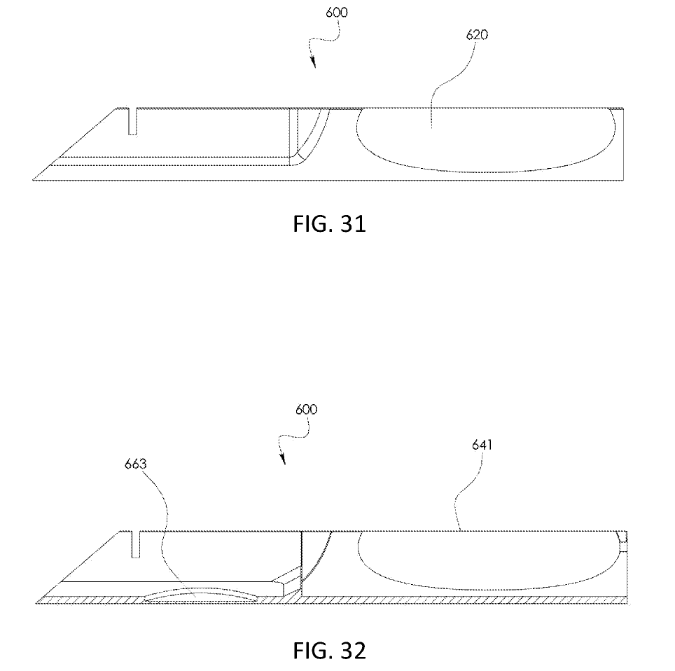

The gripping surfaces 620 of the pill dispenser 600 may extend substantially upwards and away from the bottom of the pill dispenser 600. The pill dispenser 600 may also include sidewalls 641 which may aid in gripping, bottle retention, material retention, or improved rigidity of the pill dispenser 600. In the embodiment shown, the receiving surface 610 is substantially curved and the curvature may extend at least partially to form sidewalls 641 for the pill dispenser 600. FIGS. 27, 28, 29, 30, 31, and 32, show a top view, rear view, bottom rear isometric view, front view, side view, and side cross-sectional view, respectively, of the pill dispenser 600.

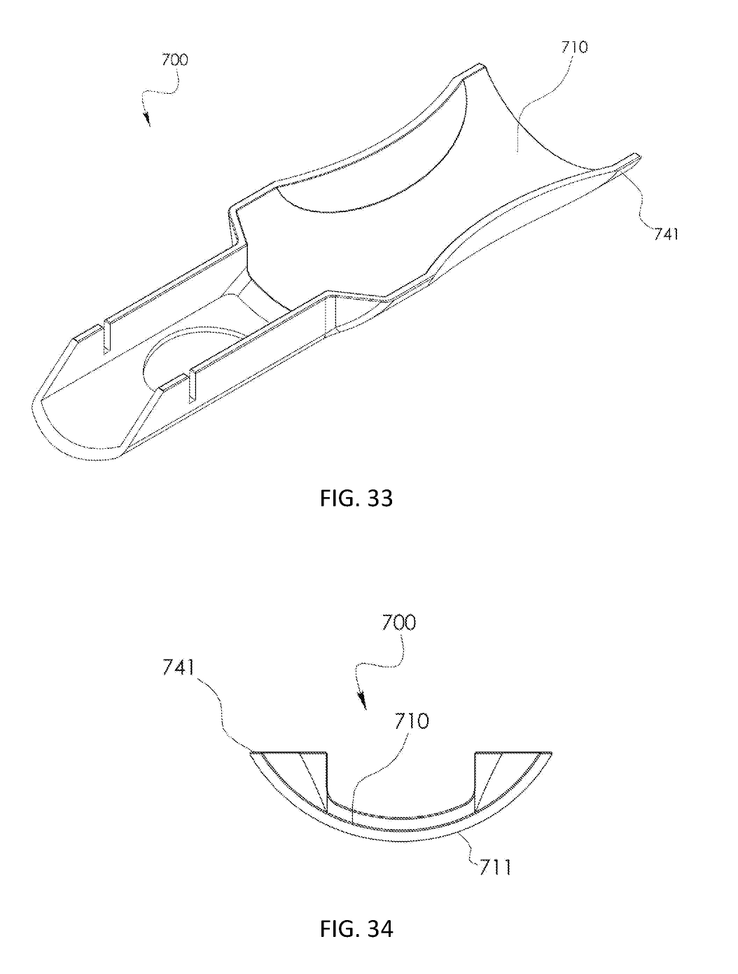

FIG. 33 shows a pill dispenser 700 which is similar to that of FIG. 26. The embodiment of the pill dispenser 700 of FIG. 33 includes sides 741 to the receiving surface 710 which do not extend the curvature of the receiving surface 710 as substantially away from the bottom 711 of the pill dispenser 700 as do those of FIG. 26. FIG. 34 shows a rear view of the pill dispenser 700.

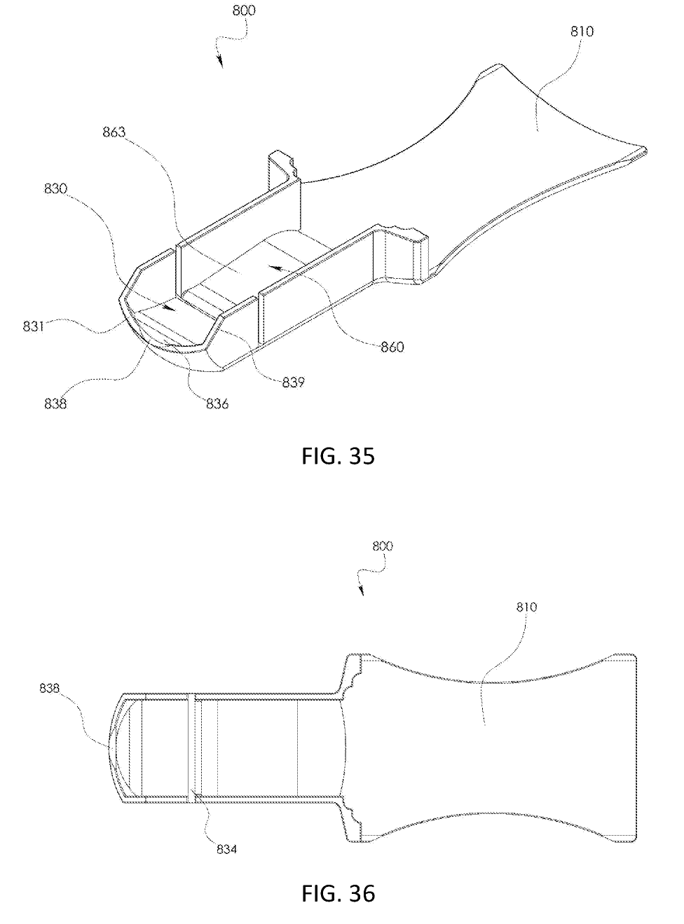

FIG. 35 shows a front top isometric view of another embodiment of a pill dispenser 800. The retention area 860 may include a curved surface 863 or a surface 863 including multiple curves or complex curves. A ramped surface 824 may aid in directing material into the retention area 860. The ramped surface 824 may direct material at least partially upwards away from the receiving surface 810. The dispensing area 830 may include a curved surface 836 or other ramp surface 836 to aid in directing material towards the dispensing tip 831. The curved or other ramp surface 836 in the dispensing area 830 may also aid in reducing the likelihood of material dispensing from the pill dispenser 800 when it is not desired. The barrier 150 may fit between the retention area 860 and the dispensing area 830 or the dispensing tip 831, such as through a slot 837. The barrier 150 may be configured to seat evenly with the dispensing area 830 or retention area 860 or may seat below or above one or both the dispensing area 830 and the retention area 860.

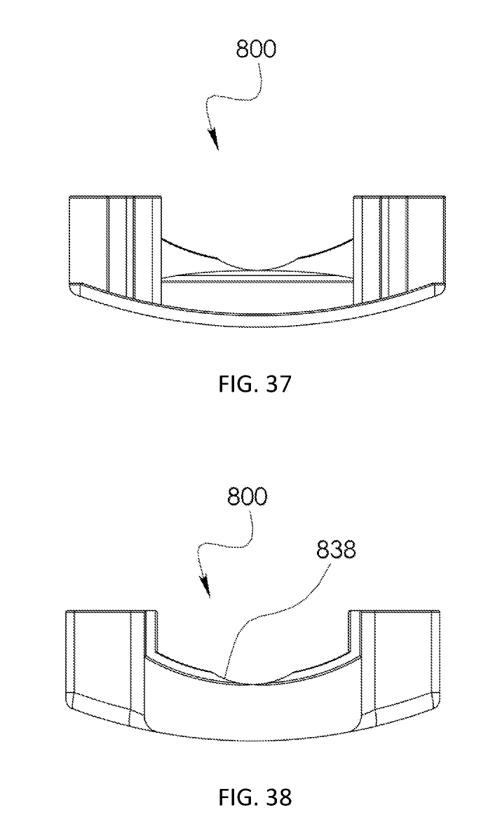

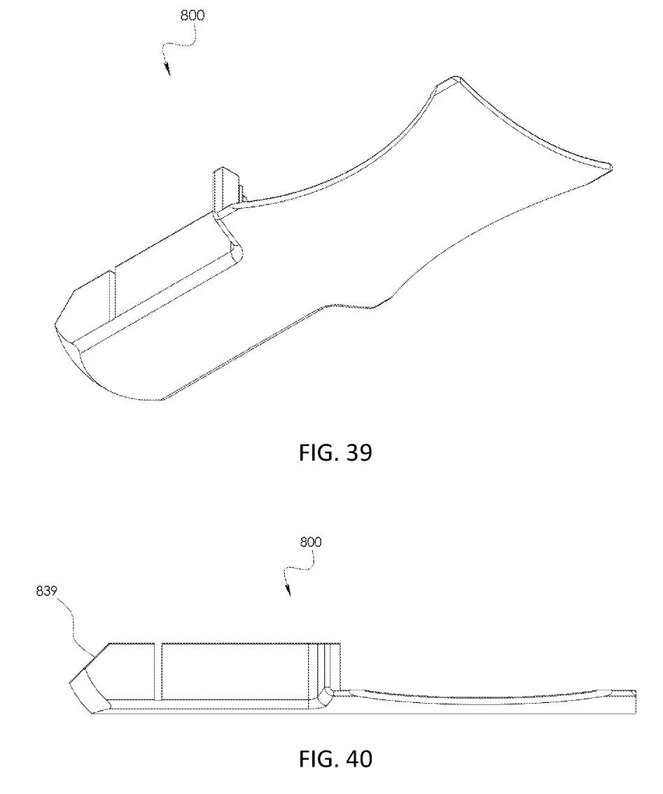

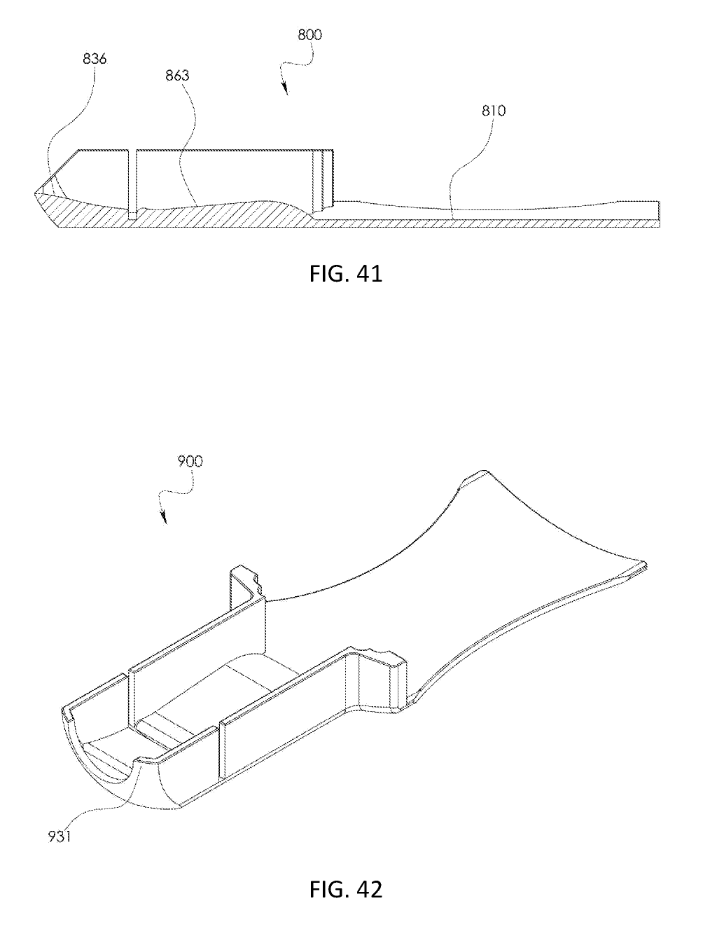

The dispensing tip 831 of the embodiment of FIG. 35 may be at least partially curved. It may also include an at least partial recess 838 to aid in dispensing. The dispensing tip 831 may also include one or more angled surfaces 839 to aid in visualizing the material as it is dispensed or to aid in fitting the dispensing tip 831 within or in proximity to a target volume 181 or surface. FIGS. 36, 37, 38, 39, 40, and 41, show a top view, rear view, front view, bottom rear isometric view, side view, and side cross-sectional view, respectively, of the pill dispenser 800.

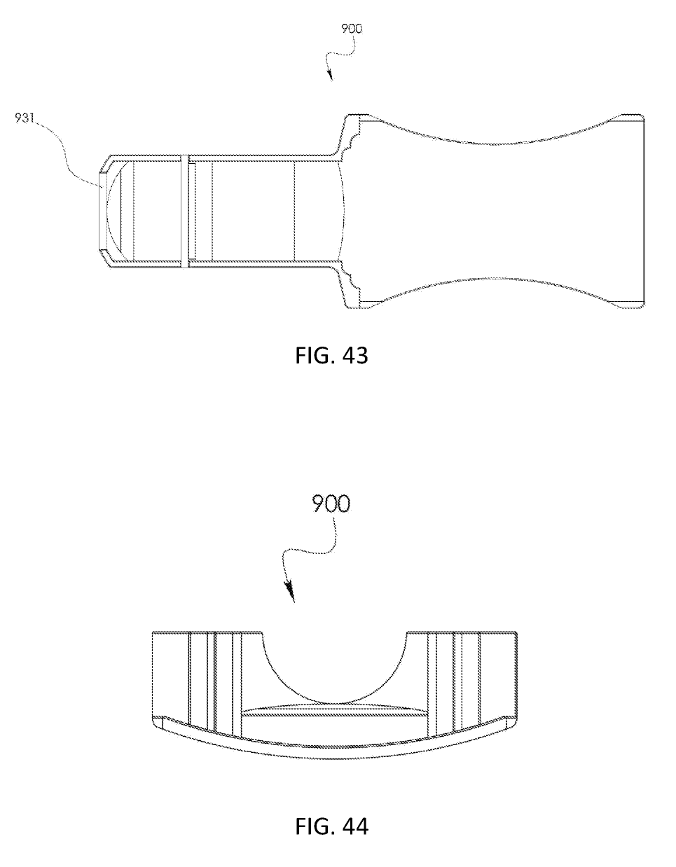

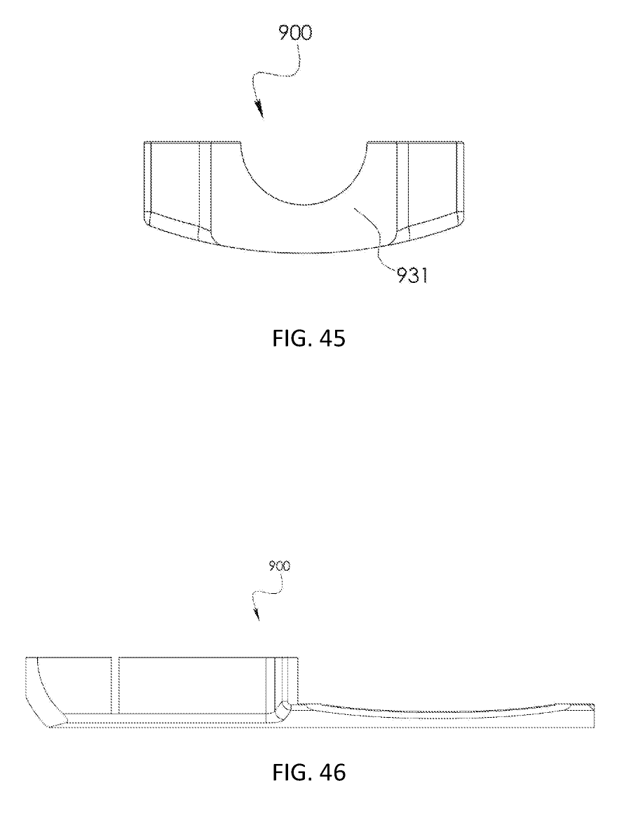

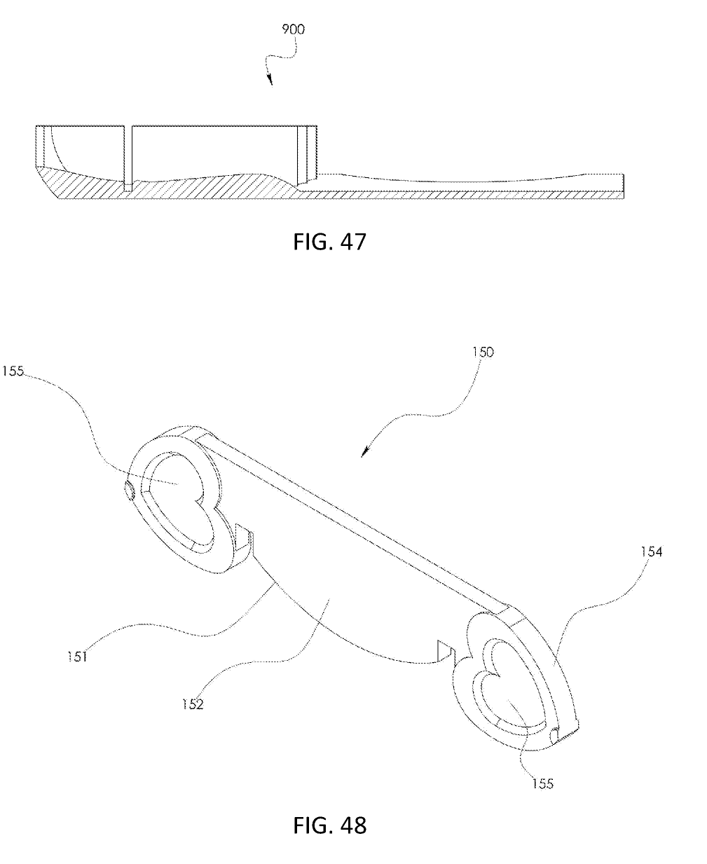

FIG. 42 shows a front top isometric view of an embodiment of the pill dispenser 900 which is similar to that of FIG. 35. The pill dispenser 900 of FIG. 42 has a dispensing tip 931 which is substantially semi-circular. The walls of the dispensing tip 931 may aid in retention of material to aid unintentional dispensing. FIGS. 43, 44, 45, 46, and 47, show a top view, a rear view, a front view, a side view, and a side cross-sectional view, respectively, of the pill dispenser 900.

FIG. 48 shows a front top isometric view of a barrier 150. The barrier 150 may include a substantially planar surface 152, though an at least partially curved or at least partially angled surface may also be used. The barrier 150 may include a bottom surface 151. In the embodiment shown, the bottom surface 151 is substantially curved, though it should be understood that other shapes and forms of the bottom surface 151 may also be used. The bottom surface 151 may be configured to at least partially conform to one or more surfaces of the pill dispenser 100, such as part of the retention area 160 or part of the dispensing area 130. The barrier 150 may include one or more recessed surfaces or notches 153 which may aid in retaining the barrier 150 between the retention area 160 of the pill dispenser 100 and the dispensing area 130 or dispensing tip 131 of the pill dispenser 100, such as in one or more slots 105 in the pill dispenser 100. The recessed surfaces or notches 153 may also aid the user in sliding the barrier 150 along the pill dispenser 100 when wishing to dispense material.

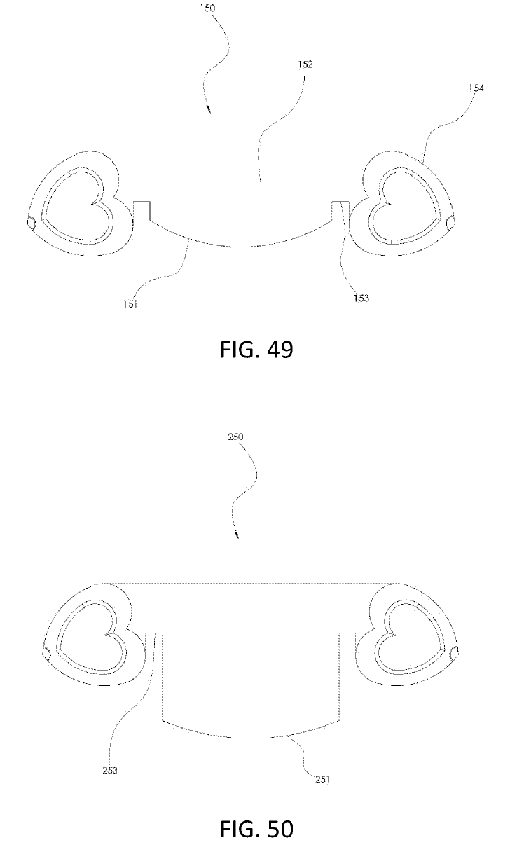

The barrier 150 may include one or more gripping features 154 to aid the user in holding the barrier 150 or in sliding it along the pill dispenser 100. In the embodiment shown, the gripping features 154 are substantially heart-shaped and include recessed surfaces 155 for easier holding or better gripping. It should be understood that other shapes and features may also be used without deviating from the scope or intent of this disclosure. FIG. 49 shows a front view of the embodiment of the barrier 150 of FIG. 48. It should be understood that, though the bottom surface 151 is shown substantially convex, it may also be flat, concave, angled, or have other shapes or features which may conform to various embodiments of the pill dispenser 100 or may otherwise be found to be beneficial or desirable in retaining material, pushing material, or otherwise interfacing with the pill dispenser 100.

FIG. 50 shows a front view of an alternate embodiment of a barrier 250. The bottom surface 251 of the barrier may be substantially below the recessed surfaces or notches 253, aiding in blocking more material, pushing more material so as to dispense the material, or in having less deep slots 105 in the pill dispenser 100 relative to the depth of the retention area 160 or dispensing area 130.

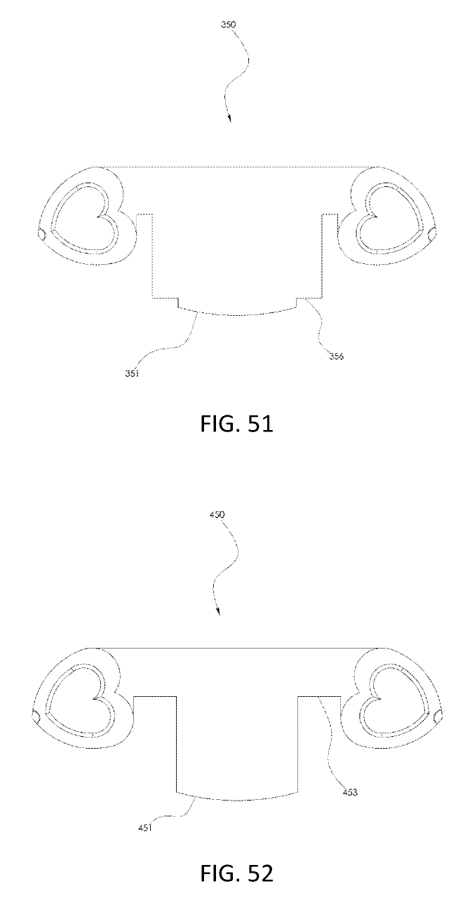

FIG. 51 shows a front view of another alternate embodiment of the barrier 350 of the present disclosure. The barrier 350 may include one or more secondary bottom surfaces 356, which are shown substantially flat but may be curved or angled. The secondary bottom surfaces 356 may aid in retaining or pushing material through a retention area 160 or dispensing area 130, which may include both an at least partially curved surface and a substantially flat surface.

FIG. 52 shows a front view of another embodiment of a barrier 450. The recessed surfaces 453 are shown as forming a more significant portion of the width of the barrier 450 than those of the embodiment of FIG. 48.

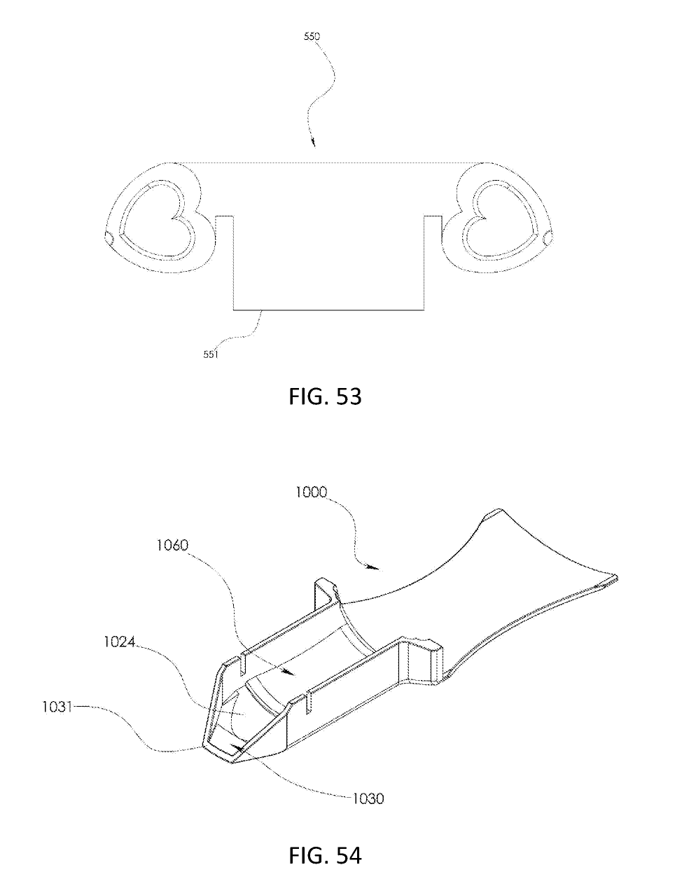

FIG. 53 shows a front view of another embodiment of the barrier 550 of the present disclosure. The bottom surface 551 is shown as substantially flat.

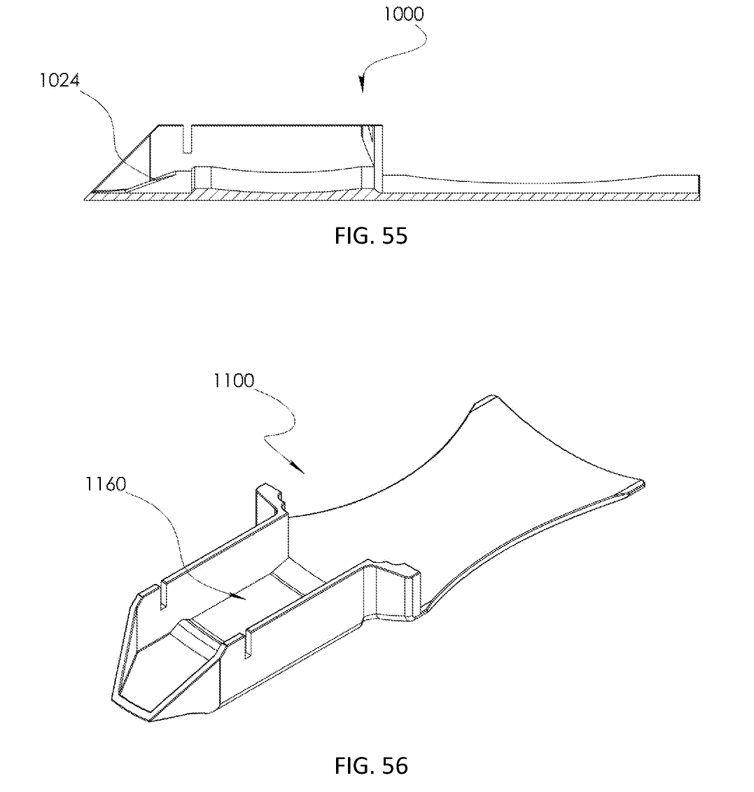

FIG. 54 a front top isometric view of another embodiment of the pill dispenser 1000. The pill dispenser 1000 includes a ramp 1024 in the dispensing area 1030 which aids in directing pills or other materials from the retention area 1060 towards the dispensing tip 1031. FIG. 55 shows a side cross-sectional view of the pill dispenser 1000.

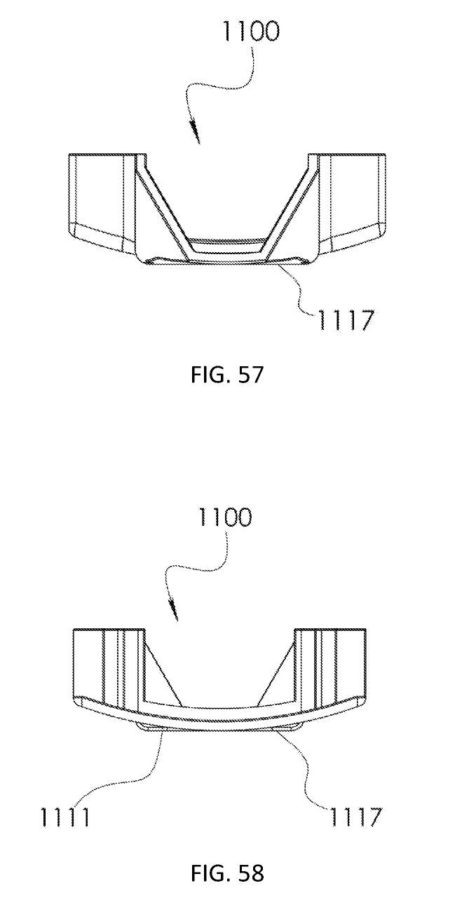

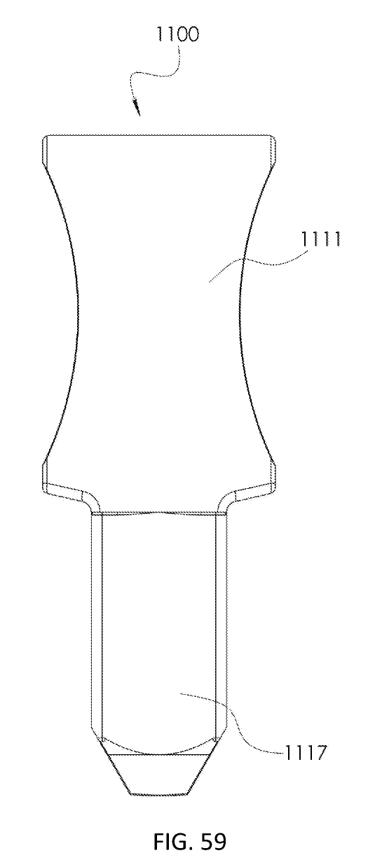

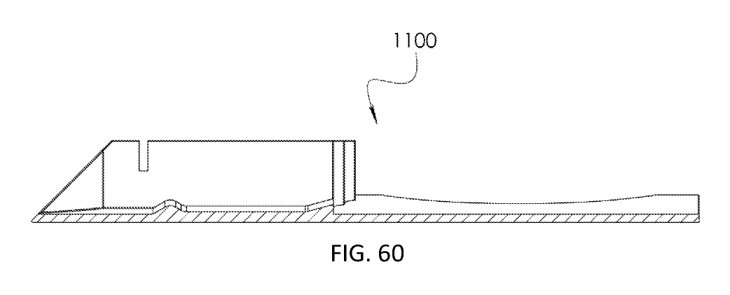

FIG. 56 shows a front top isometric view of a pill dispenser 1100. The pill dispenser includes a substantially curved bottom surface 1111, where a user would typically hold the pill dispenser 1100 during use. The pill dispenser 1100 also includes a substantially planar surface 1117 to aid in keeping the pill dispenser 1100 stable when resting upon a flat surface, such as when pills are being poured from a pill bottle 190 into the retention area 1160. FIGS. 57, 58, 59, and 60, show a front view, a back view, a bottom view, and a side cross-sectional view, respectively, of the pill dispenser 1100.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention. Accordingly, various modifications, adaptations, combinations, and alternatives may occur to one skilled in the art without departing from the spirit of the invention and scope of the claimed coverage.

What is claimed is:

1. A device for dispensing material, comprising:
a length extending from a first end of the device to a second end of the device;
a first wall;
a second wall;
a material receiving area comprising a material receiving surface;
a dispensing tip;
a container receiving surface; and
a bottom surface;
wherein the bottom surface comprises at least one curved surface which defines a longitudinal axis which extends substantially along the length, the first wall extends substantially parallel to the longitudinal axis, the second wall extends substantially parallel to the longitudinal axis, and wherein the first wall, the second wall, and the receiving surface define a first receiving volume in the receiving area, and further wherein the first receiving volume is at least partially open, and wherein the dispensing tip further comprises a dispensing end located proximate to the first end and substantially on an opposing side of the material receiving surface from the container receiving surface along the longitudinal axis.

2. The device according to claim 1, further wherein the first wall and the second wall extend substantially away from the bottom surface relative to a perpendicular axis which is perpendicular to the longitudinal axis and the bottom surface.

3. The device according to claim 1, further wherein the dispensing tip at least partially defines a dispensing opening proximate to the dispensing end.

4. The device according to claim 1, further wherein the container receiving surface is at least partially concave and the bottom surface is at least partially convex.

5. The device according to claim 4, further wherein the bottom surface further comprises at least one convex surface and at least one substantially planar surface.

6. The device according to claim 4, further wherein the container receiving surface is configured to receive at least one diameter of a cylindrical container along a circumference of the container.

7. The device according to claim 6, further comprising a blocking surface, wherein the blocking surface is proximate to at least one of the first wall and the second wall, and further wherein the blocking surface creates an included angle between 0 degrees and 90 degrees relative to the container receiving surface.

8. The device according to claim 1, further wherein the material receiving surface is at least partially concave.

9. The device according to claim 1, further wherein the first receiving volume is defined by at least one surface which is not parallel with the material receiving surface.

10. The device according to claim 2, further wherein at least one of the first wall and the second wall define a slot opening configured to receive a barrier member.

11. The device according to claim 10, further wherein the material receiving surface is configured to at least partially align with a barrier bottom surface of the barrier member.

12. The device according to claim 10, further comprising a dispensing area at least partially between the material receiving surface and the dispensing tip and further wherein the slot opening is configured so that the barrier member may at least partially separate the material receiving volume from the dispensing area when the barrier member is at least partially inserted into the slot opening.

13. The device according to claim 12, further wherein a barrier bottom surface of the barrier is configured to substantial align with at least part of the material receiving surface.

14. The device according to claim 13, further wherein at least one of the first wall and the second wall comprises an upper surface which is configured to allow a barrier member to slide at least partially through the material receiving volume.

15. The device according to claim 14, further wherein at least one of the first wall or the second wall comprises an upper wall surface, and further wherein the barrier member is configured to be able to be slidably moved between at least part of the receiving area and into at least part of the dispensing area when at least part of the barrier member is in contact with the upper wall surface.

16. The device according to claim 15, further wherein the barrier bottom surface is at least partially convex.

17. The device according to claim 16, further wherein the dispensing tip comprises at least one surface which not parallel and not perpendicular to the bottom surface.

18. A method of dispensing medication, comprising:
placing a container of medication proximate to a container receiving surface of a dispenser device;
enabling medication to fall out of the container of medication into a retention volume in the dispenser device; and
enabling medication to leave the dispenser device through a dispenser tip into a target volume;
wherein the dispenser tip at least partially defines a dispenser opening and the dispenser device comprises at least one convex bottom surface.

19. The method according to claim 18, further comprising removably connecting a barrier member to the dispenser device wherein the barrier member is proximate to at least one side of the retention volume so as to substantially impede movement of the medication out of the retention volume towards the dispensing tip.

20. The method according to claim 19, further comprising at least partially removing the barrier member from the dispenser device and using it to aid in moving medication out of the retention volume towards the dispensing tip.
